(19) United States
(12) Patent Application Publication
(10) Pub. No.: US 2004/0156975 A1
(43) Pub. Date: Aug. 12, 2004

(54) Methods of manufacturing aseptic tofu using nano- or ultrafiltration

(75) Inventors: Gosta Odelberg-Johnson, Singapore (SG); Sharon Kong, Singapore (SG); Nazlin Imram, Singapore (SG); Alan Lu, Singapore (SG)

Correspondence Address: BURNS, DOANE, SWECKER & MATHIS, L.L.P., P.O. Box 1404, Alexandria, VA, 22313-1404, US

(73) Assignee: Tetra Laval Holdings & Finance S.A.

(21) Appl. No.: 10/359,623

(22) Filed: Feb. 7, 2003

(51) Int. Cl. A23L 1/20

(52) U.S. Cl. 426/634

(57) ABSTRACT

The present invention relates to a method of manufacturing aseptic tofu using nano- or ultrafiltration. The method includes extracting soy base from soybeans and nano- or ultrafiltering the soy base, thereby concentrating the soy base protein and increasing the total solids of the soy base. The process further includes sterilizing and homogenizing the soy base and finally, mixing the soy base with a coagulant in an aseptic mixing process.

### BACKGROUND OF THE INVENTION

1. Field of the Invention

The present invention is directed to methods of manufacturing aseptic tofu. In particular, the present invention is directed to methods of manufacturing aseptic tofu using nano- or ultrafiltration.

2. Description of the Related Art

Soybean products, especially a soybean curd called tofu, have recently become a popular high-protein food. It is desirable that the tofu have a firm texture so that the tofu does not lose its shape when it is cooked. In order to produce tofu having a firm texture, a soy protein isolate is added to the soybean protein. The addition of soy protein isolate increases firmness somewhat, however, greater firmness often is desired.

With the development of glucono-delta-lactone (GDL) as a food product additive, new methods for producing tofu using GDL as a coagulant have been developed. Tofu products including GDL are more easily produced in large quantities and have greater storage stability than tofu products produced by conventional processes. However, addition of too much of a coagulant, such as GDL, to increase the firmness of the tofu product, will adversely affect the taste of the tofu product.

In order to increase shelf life of the tofu product, packaged soybean base can be heat sterilized by a retort sterilization treatment. The tofu produced by retort sterilization is called retort tofu or fresh tofu.

In order to further increase the shelf life of the tofu product, it is desirable that tofu products be aseptically packaged. Aseptic packaging of tofu increases the range of distribution which is available to the tofu producer. Processes for aseptic packaging of tofu include a step of ultra high temperature (UHT) treatment of the soybean base prior to packaging. However, such UHT treatment processes have a tendency to adversely affect the taste and/or texture of the final product when compared to non-aseptically packaged or fresh tofu.

One disadvantage associated with existing processes for aseptic tofu preparation is the need to add soy protein isolate to produce tofu having a firm texture. The addition of isolated soy protein during tofu production requires additional processing, which increases manufacturing costs. In addition, once added, the isolated soy protein produces an undesirable bitter flavor.

Accordingly, there is an urgent need for a process for producing aseptic tofu that avoids the need to add isolated soy protein to achieve desired firmness.

### SUMMARY OF THE INVENTION

The process of the present invention uses nano- or ultrafiltration to produce aseptic tofu that exhibits enhanced firmness without the addition of conventional levels of isolated soy protein. Thus, the process of the present invention can produce aseptic tofu with enhanced firmness without the additional processing and expense associated with the addition of conventional levels of isolated soy protein. Moreover, by eliminating the need for isolated soy protein, the process of the present invention can also produce tofu that has less bitterness and astringency than tofu products prepared with isolated soy protein.

In an exemplary embodiment, the process includes extracting soy base from soybeans and nanofiltering the soy base, thereby concentrating the soy base protein and increasing the total solids content of the soy base. Because those of ordinary skill in the art use both “nanofiltration” and “ultrafiltration” to refer to filtration with a filter having a pore size in the range of about 50 nm to about 100 nm, the terms “nanofiltering” and “nanofiltration,” as used herein, are intended to also refer to “ultrafiltering” and “ultrafiltration,” respectively. The process further includes sterilizing and homogenizing the soy base. Additionally, the process includes mixing the soy base with a coagulant in an aseptic mixing process.

In another embodiment, the process includes extracting soy base from soybeans and feeding the soy base through a nanofiltration unit so that after filtration, the soy base has a solids content of at least about 16° Brix. The term “Brix” is used herein, in accordance with its conventional meaning, as an approximate measurement of soluble solids. The soy base is then subjected to ultra-high temperature sterilization wherein the soy base is heated from about 132° C. for about 15 seconds to about 142° C. for about 2 seconds. Next, the soy base is homogenized. The process further includes mixing the soy base with a coagulant, comprising TG (Transglutaminase), GDL, MgCl₂, and at least one salt selected from the group consisting of NaCl and a calcium salt, in an aseptic mixing process.

In another embodiment, the process includes extracting soy base from soybeans and feeding the soy base through a nanofiltration unit so that after filtration the soy base has a solids content of at least about 16° Brix. The process includes subjecting the soy base to ultra-high temperature sterilization process wherein the soy base is heated to about 132° C. for about 15 seconds to about 142° C. for about 2 seconds. Next, the soy base is homogenized. The process further includes first mixing the soy base with about 23.25% by weight TG and about 76.75% by weight water at a flow rate of about 20 liters per hour, followed by mixing with about 20% by weight GDL, about 6.73% by weight MgCl₂ about 6.73% by weight NaCl and about 66.54% by weight water at a flow rate of about 25 liters per hour.

In particular, in a preferred embodiment, the invention provides a method of manufacturing a tofu product from soybeans, the method comprising extracting soy base from the soybeans; nanofiltering the soy base, thereby concentrating the soy base protein and increasing the total solids content of the soy base; sterilizing and homogenizing the soy base; and mixing the soy base with a coagulant in an aseptic mixing process.

In another preferred embodiment, the invention further provides a method of manufacturing a tofu product comprising: extracting soy base from soybeans; feeding the soy base through a nanofiltration unit so that after filtration, the soy base has a solids content of at least about 16° Brix; subjecting the soy base to an ultra-high temperature sterilization process wherein the soy base is heated from about 132° C. for about 15 seconds to about 142° C. for about 2 seconds; homogenizing the soy base; and mixing the soy base with a coagulant comprising TG, GDL, MgCl₂ and at least one salt selected from the group consisting of NaCl and a calcium salt.

In a further preferred embodiment, the invention provides a method of manufacturing a tofu product from soybeans, the method comprising: extracting soy base from the soybeans; feeding the soy base through a nanofiltration unit so that after filtration the soy base has a solids content of at least about 16° Brix; subjecting the soy base to an ultra-high temperature sterilization process wherein the soy base is heated to about 132° C. for about 15 seconds to about 142° C. for about 2 seconds; homogenizing the soy base; and mixing the soy base with a coagulant comprising providing the soy base at a flow rate of about 1,500 liters per hours and combining the soy base with about 23.25% by weight TG and about 76.75% by weight water at a flow rate of about 20 liters per hour, and then combining the soy base with about 20% by weight GDL, about 6.73% by weight MgCl₂, about 6.73% by weight NaCl and about 66.54% by weight water at a flow rate of about 25 liters per hour.

### BRIEF DESCRIPTION OF THE DRAWING FIGURES

The invention will be described in greater detail with reference to the accompanying drawings in which like elements bear like reference numerals, and wherein:

FIG. 1 is a schematic diagram of a process for preparation of a soy base product according to the present invention;

FIG. 2 is a schematic diagram of a process for ultra-high temperature treatment of soy base according to the present invention; and

FIG. 3 is a schematic diagram of the incubation processing of the packaged tofu.

### DETAILED DESCRIPTION OF THE PREFERRED EMBODIMENTS

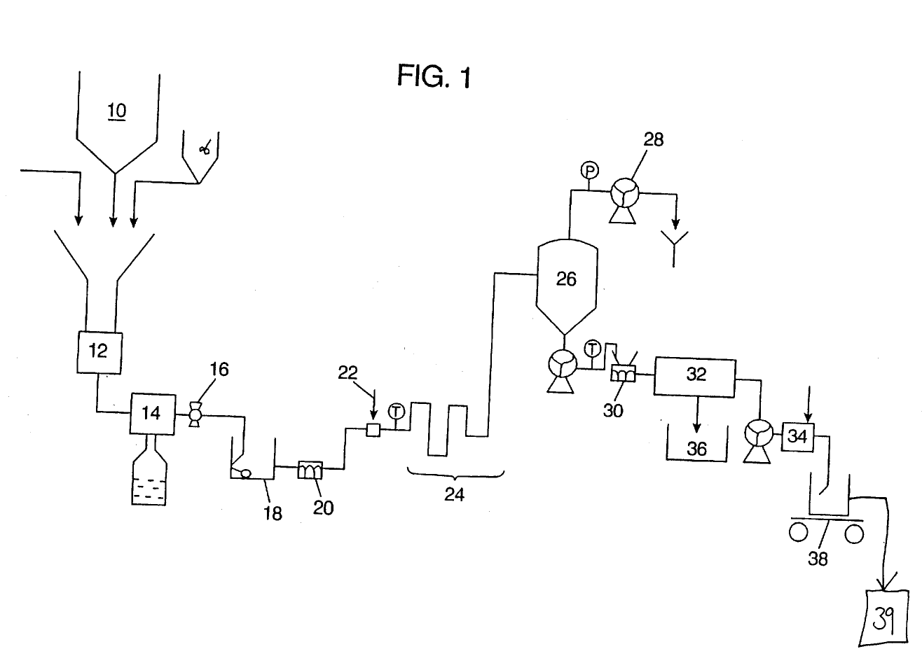

The method according to the present invention for producing an aseptic tofu product includes steps of extracting soy base from soybeans, nanofiltering (or ultrafiltering) the soy base, sterilizing the soy base, homogenizing the soy base and mixing the soy base with a coagulant. In a preferred embodiment, the soy base is extracted from soybeans using the process shown in FIG. 1.

In FIG. 1, the soybeans are prepared by soaking the soybeans in hypochlorite, rinsing the soybeans with tap water, and then soaking the soybeans in tap water in the soaking hopper 10 for a period of between about 3 hours and about 15 hours, preferably between about 5 hours and about 12 hours, and even more preferably about 5 hours to about 6 hours at about 25° C. Alternatively, the step of soaking in hypochlorite can be omitted and the soybeans can be prepared by a one-step soaking process by soaking the soybeans in tap water for about 5 hours at about 25° C. However, when omitting the hypochlorite soaking step, the beans must be as clean as Canadian beans grade 1.

After soaking, the water is drained from the soaked beans. The prepared soybeans are then combined with an anti-foaming suspension and water, and fed into a first grinder 12 where the soybeans are ground.

Suitable anti-foaming agents are commercially available in powdered and/or liquid form. Preferred anti-foaming agents include, but are not limited to, the anti-foaming agent powder available from Tosu Suppliers Trading Co., including about 92.5% glycerine fatty acid ester, about 4% soybean lecithin, about 3% calcium carbonate, and about 0.5% silicon resin. The powdered anti-foaming agent is added to the soybean in a suspension, which is preferably about 0.5% to about 1.5% anti-foaming agent, and more preferably about 0.7% to about 1.0% anti-foaming agent. Because the anti-foaming agent does not dissolve in water, the suspension should be subject to relatively constant stirring. Other suitable anti-foaming agents include, for example, anti-foaming agent powders available from Tosu supplies and Wacker Chemical Pte Ltd. (South Asia), which can comprise polydimethylsiloxane and a filler emulsion. These agents can be used at about 0.01% by weight to about 0.5% by weight.

From the first grinder 12, the soybean is transported to a second grinder 14 where it is more finely ground to produce a soybean slurry. The first grinder 12 is preferably a disc mill grinder, while the second grinder is preferably a colloid mill grinder. However, other types of grinders can also be used in place of the disc mill and colloid mill grinders.

The soybean slurry is then pumped by rotary pump 16 from the second grinder 14 into the holding hopper 18 where it is agitated to prevent separation. The soybean slurry is then transported out of the holding hopper 18 by the positive displacement pump 20 and cooked by the injection of culinary steam. The culinary steam is injected at a steam injection port 22 directly into the soybean slurry, which is being transported through a tube. The slurry is heated to between about 90° C. and about 110° C., preferably between about 95° C. and about 105° C., and more preferably about 100° C. by the steam injection. The slurry is then held for a period of time by means of the holding tube 24. The holding time in the holding tube 24 is between about 1 minute and about 10 minutes, preferably between about 2 minutes and about 6 minutes, and more preferably about 4 minutes.

The cooked slurry is pumped by a second positive displacement pump 30 into a decanter 32 where the soy base is extracted from the soybean slurry by removing the fibrous material and curd residue, called okara. The okara is collected in the hopper 36. The extracted soy base, which has a soluble solids content between about 11° Brix and about 15° Brix, and preferably about 13° Brix to about 14° Brix, is cooled to a temperature of about 3° C. to about 20° C., preferably about 5° C. to about 10° C., by cold water flowing through a heat exchanger 34.

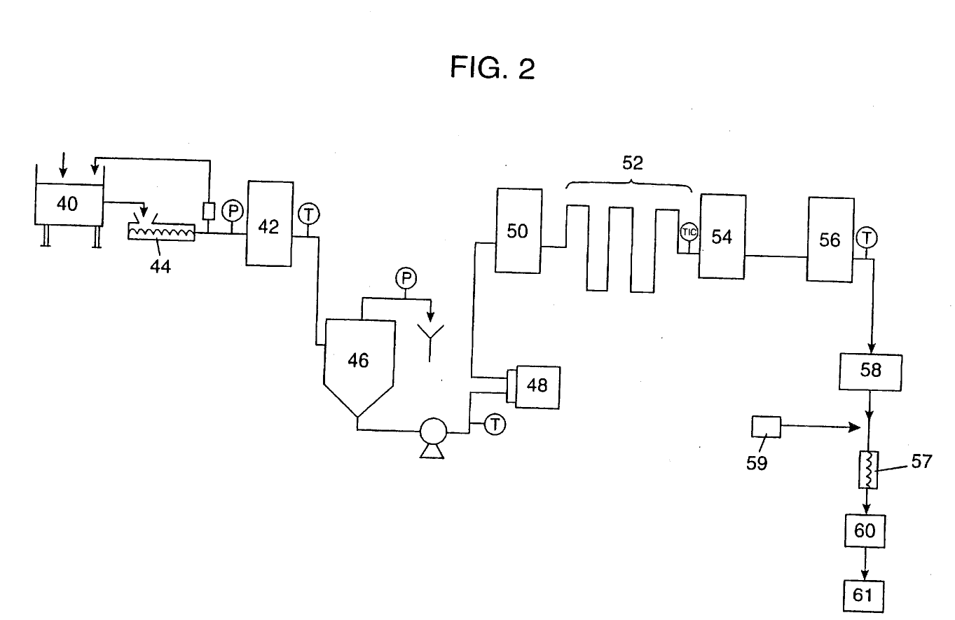

The soy base, which has been extracted by the process of FIG. 1, is received in a hopper 38 in which the soy base may be stored for a period of time before further processing. Alternatively, the soy base is transported directly to the UHT treatment process, shown in FIG. 2, for immediate use in the production of aseptic tofu. When the soy base passes immediately to the UHT treatment process, the cooling by the heat exchanger 34 may not be necessary. Temperature and pressure are preferably monitored during the process by the temperature and pressure sensors TP. The system of FIG. 1 for the extraction of soy base from soybean is the Tetra Alwin® soy plant.

The soy base, which has been extracted, for example, in the extraction process illustrated in FIG. 1, is then processed by an UHT treatment process. However, prior to UHT treatment, the soy base can be run through a nanofiltration (or ultrafiltration) unit 39. The soy base preparation for a firm tofu product includes nanofiltering the soy base to produce a soy base having a total solids content of at least about 16° Brix.

A suitable nanofiltration unit is a Tetra Alcross® Pilot scale ultrafiltration unit. Suitable nano- or ultrafiltration units, such as the Tetra Alcross® unit, can include a balance tank, a feed pump, a loop cooler, a 2× tubular PVDF membrane house (ceramic membranes are also suitable) having a pore size of about 10 nm to about 100 nm, preferably about 20 nm to about 50 nm, a pressure transmitter and a thermometer. Additionally, a suitable nanofiltration unit can operate at an inlet pressure of about 1.5 bar to about 5 bar, preferably at about 1.5 bar to about 2.5 bar. Also, suitable units can be operated at about 50° C. to about 55° C. at a flux of at least about 15 L/h to about 20 L/h.

Additionally, while not required in the process of the present invention, further enhancement of the tofu product firmness and/or flavor may be achieved by adding soy protein isolate, such as, for example, SAMPROSOY 90 NB. Preparation of soy base including the mixing of a soy protein isolate is described, for example, in U.S. Pat. No. 5,863,590, the entire disclosure of which is hereby incorporated by reference. Of course, as the nanofiltration process of the invention is sufficient to impart suitable tofu firmness, any amount of soy protein isolate added should be less than amounts used in conventional tofu manufacturing processes. That is, it may be advantageous to add a small amount of soy protein isolate such as, for example, less than about 2% by weight.

Homogenization of the soy base is preferably conducted in a two-stage process, which is carried out at pressures of about 100 bar to about 140 bar, preferably about 110 bar to about 130 bar for the first stage, and about 10 bar to about 50 bar, preferably about 20 bar to about 40 bar for the second stage. This two-stage homogenization process is the first of two such two-stage homogenization processes. Generally, the first two-stage process is only performed when using soy protein isolate. The soy base is subjected to the second two-stage homogenization process during UHT treatment. The prepared soy base product is cooled for storage to a temperature of about 0° C. to about 20° C., preferably about 5° C. to about 10° C., by cold water flowing through a heat exchanger. Alternatively, the prepared soy base can be passed directly to a buffer tank 40 of the UHT process.

An UHT process, in accordance with the present invention, is illustrated in FIG. 2. The prepared soy base product is pumped from a buffer tank 40 into a preheater 42 by a positive displacement pump 44. The soy base is preheated to a temperature of about 65° C. to about 100° C., preferably about 75° C. to about 90° C. in the preheater 42 and then deaerated at about 57° C. to about 85° C., preferably about 67° C. to about 82° C. in a deaerator vessel 46. The preheater can be any known type of heater, indirect or direct, such as, for example, a steam-injection heater, a plate-type heater or a tubular heater. In preferred embodiments, the preheater is a direct heater.

The soy base, which has been deaerated, is then pumped into a homogenizer 48. The homogenizer 48 is preferably a two-stage homogenizer, which homogenizes at about 100 bar to about 170 bar, preferably about 140 bar to about 160 bar for the first stage, and about 10 bar to about 100 bar, preferably about 20 bar to about 40 bar for the second stage. Preferably, the homogenizer is a downstream homogenizer.,

After homogenization, the soy base is sterilized by a regenerative heat assembly including a main heater 50 and a holding tube 52. Alternatively, the soy base is sterilized by a direct heat assembly. The main heater 50 is an indirect heat exchanger, such as a plate-type heat exchanger. An acceptable indirect heat treatment for sterilization includes heating to about 125° C. to about 142° C., for about 1 second to about 20 seconds, preferably about 135° C. to about 142° C., for about 2 seconds to about 15 seconds. Alternatively, low temperature, longer time heat treatment can be used. Lower temperature, longer time heat treatment helps to reduce the fouling of the sterilization apparatus when processing soy base. Lower temperature, longer time heat treatment would include treatment at about 125° C. to about 142° C., for about 2 seconds to about 65 seconds, preferably about 135° C. to about 142° C., for about 2 seconds to about 15 seconds. Suitable system for the aseptic processing of soy base include, for example, the Tetra Therm® Aseptic Flex system and the Tetra Therm® Aseptic VTIS system, available from Tetra Pak. Examples of cominations of approximate temperatures and holding times found to achieve acceptable UHT treatment are as follows:

| Temperature (° C.) | Holding Time (seconds) |
|---|---|
| 125 | 66 |
| 130 | 20 |
| 135 | 7 |
| 140 | 2 |
| 145 | 1 |

Following the heat treatment, the soy base is preferably cooled by a two-stage cooling process. A pre-cooling heat exchanger 54 cools the aseptic soy base to between about 40° C. and about 65° C., preferably between about 50° C. and about 55° C. A final cooling heat exchanger 56 then cools the soy base to between about 5° C. and about 20° C., preferably between about 5° C. and about 10° C. The pre-cooling heat exchanger 54 can use the raw or unsterilized soy base product as a cooling medium to pre-cool the sterilized soy base. At the same time, the heat exchanger 54 improves the efficiency of the overall process of preheating the raw soy base. The final cooling heat exchanger 56 can be a commercial refrigeration unit.

The cooled aseptic soy base should be transferred to an aseptic buffer tank 58 such as a Tetra Alsafe® unit where the soy base is stored temporarily. The cooled aseptic soy base is then transferred to an aseptic filler 60 by means of air pressure in the aseptic tank 58. The dosing of coagulant into the soy base is done by injecting the sterilized coagulant into the soy base and can be performed by any suitable aseptic dosing apparatus 59. Suitable dosing apparatuses can include, for example, the Tetra Aldose® unit and the Tetra Lacta® unit, available from Tetra Pak or aseptic dosing bags, available from Arom Pak. In preferred embodiments, the Tetra Aldose® or the Tetra Lacta® unit are used. Preferably, the dosing apparatus 59 includes a filter by which the microbes in the coagulant solution can be filtered off.

A preferred coagulant solution for use in the process according to the present invention is prepared by mixing TG, GDL, MgCl₂, and NaCl. A coagulant comprising a calcium salt such as, for example, CaCl₂ or CaSO₄ can also be used. Generally, the coagulant of the present invention is prepared separately and dosed in two stages into the UHT-treated soy base. For instance, the aseptic soy base can be dosed first with a coagulant comprising about 23.25% by weight TG and about 76.75% by weight water. Next, the soy base can be dosed with about 20% by weight GDL, about 6.73% by weight MgCl₂, about 6.73% by weight NaCl and about 66.54% by weight water. Thus, the dosing of the coagulant solutions of the invention usually occurs in stages. Usually, several dosing units are used to obtain the desired combination of coagulant components. For best results, the coagulant solutions should be used within about one hour, and preferably within about one-half hour at a maximum temperature of about 10° C., preferably below about 5° C.

Typically, TG-containing coagulants of the present invention are prepared by mixing TG and deionized water in a ratio of about 1:3.3 at a temperature of about 4° C. For example, about 3.07 Kg of deionized water at about 4° C. can be mixed with about 0.93 Kg of TG. A suitable dosing rate for TG-containing coagulants of the invention is about 20 L/h for a 1,500 l/hr continuous production line.

GDL-containing coagulants of the present invention can be prepared by mixing MgCl₂, NaCl and GDL in a ratio of about 1:1:2.97 with deionized water in a ratio of about 1:1.989 at about 4° C. For example, about 7.32 Kg of deionized water at about 4° C. can be mixed with about 2.2 Kg of GDL, about 0.74 Kg of MgCl₂ and about 0.74 Kg of NaCl. A suitable dosing rate for GDL-containing coagulants of the invention is about 27 L/h for a 1,500 l/hr continuous production line. For best results, the coagulant solutions should be used within about one hour, and preferably within about one-half hour at a maximum temperature of about 10° C., preferably below about 5° C.

The resulting aseptic soy base with the coagulant solution is further mixed by means of a static in-line mixer 57 in order to homogenize the soy base and coagulant. The mixed soy base and coagulant can then be packaged by a known aseptic packaging machine 60, such as, for example, a Tetra Brik Aseptic\3/8/9/19/21/22 (TBA\3/8/9/19/21/22) machine available from Tetra Pak. This process is continuous and involves forming packages 61 from a single sheet of pre-sterilized material, filling the packages 61 with aseptic soy base and coagulant solution, and sealing the packages 61 under aseptic conditions.

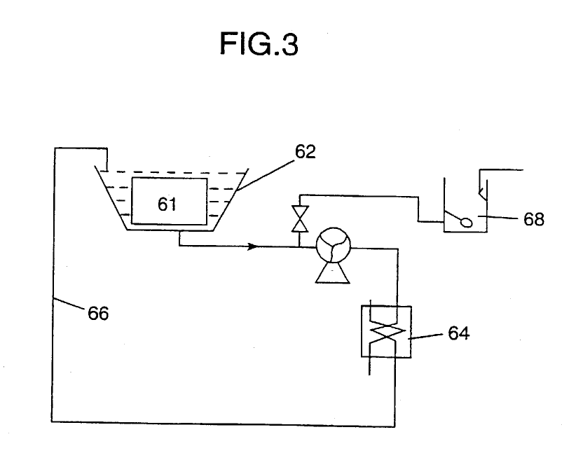

After aseptic packaging, the tofu is coagulated within the packages 61 by an incubation process described below. A water bath 62 for carrying out the incubation process is illustrated in FIG. 3. The aseptic packages of tofu 61 are submerged in the water bath 62. The tofu that has been heated by hot water heated by a heater 64 to a temperature of about 55° C. to about 60° C. for about 30 minutes, during which time the tofu within the packages 61 coagulates, is then heated to about 85° C. for about 40 minutes to deactivate the TG enzyme and thereafter cooled to about 25° C. The packages 61 are then cooled by circulating cool water from a cool water supply 68 through the circulating system 66 at a temperature of about 15° C. to about 45° C., preferably about 25° C. to about 35° C., through the water bath for about 10 minutes to about 30 minutes, preferably about 15 minutes to about 25 minutes. The tofu packages 61, which have coagulated and cooled, are removed from the water bath and can be further cooled naturally to ambient temperature.

The aseptically packaged tofu that has been prepared according to the present invention can be stored at ambient temperature for extended periods of time. The shelf life of tofu packaged according to the process of the present invention is about 6 months to about 12 months, preferably about 8 months to about 10 months.

An exemplary tofu formulation, prepared in accordance with the present invention, can include the following ingredients:

| Ingredients | % W/W |
|---|---|
| Soy base (18° Brix) | 96.96 |
| TG | 0.3 |
| Glucono delta Lactone | 0.35 |
| Magnesium chloride | 0.12 |
| Sodium chloride | 0.12 |
| Water | 2.15 |
| TOTAL: | 100.0 |

The specific apparatus shown in FIGS. 1-3 are shown by way of example, however, each of these apparatuses can be modified or replaced by other known apparatuses that perform similar functions.

The following example of a process for producing aseptically packaged tofu is provided herein for purposes of illustration only and is not intended as a limitation on the scope of the invention.

### EXAMPLE 1

Canadian soybean in an amount of about 180 kilograms was prepared by soaking in tap water at about 25° C. to about 30° C. for about 5 hours. The water was drained out and the prepared bean was supplied at about 160 kilograms per hour to a grinding disc mill along with an about 0.78% solution of an anti-foaming agent supplied at about 25 kilograms per hour and water was supplied at about 150 kilograms per hour.

The anti-foaming agent used was a liquid including about 30% silicone resin, about 3.0% sorbitan fatty acid ester, about 1.0% glycerine fatty acid ester, about 0.5% sucrose esters of fatty acids and water of about 65.5%.

The soybeans were ground a first time in the disk mill and a second time in a colloid mill to form a slurry. The slurry was then cooked at about 100° C. for about 4 minutes by steam injection. The slurry was then deaerated with zero vacuum and then a decanter was used to separate the okara.

The resulting soy base, having a total solids content of about 14° Brix was cooled to about 55° C. The soy base was then run through a suitable nanofiltration unit such as, for example, a Tetra Alcross® unit, to concentrate the content solids from about 14° Brix to about at least 16° Brix.

The concentrated soy base was stored in a buffer tank prior to UHT processing. The UHT processing included preheating the soy base to about 75° C. in an indirect tubular heat exchanger, deaerating to about 70° C., sterilizing at about 138° C. for about 4 seconds in a tubular heat exchanger, pre-cooling to about 75° C., conducting a first homogenization at about 150 bar, conducting a second homogenization at about 30 bar and performing final cooling to about 10° C.

Alternatively, the UHT processing can include preheating to about 75° C. in a direct steam injection (VTIS) combined with a tubular heat exchanger, sterilizing at about 142° C. for about 2 seconds in a direct steam injection chamber, flash cooling to about 75° C., conducting a first homogenization at about 150 bar, conducting a second homogenization at about 30 bar and performing final cooling to about 10° C.

The aseptic soy base at a flow rate of about 1,500 liters per hour was first dosed with about 23.25% by weight TG and about 76.75% by weight water at a flow rate of about 20 liters per hour and then dosed with about 20% by weight GDL, about 6.73% by weight MgCl₂, about 6.73% by weight NaCl and about 66.55% by weight water at a flow rate of about 25 liters per hour and mixed well with a static in-line mixer.

The aseptic soy base dosed with coagulant was then aseptically packaged in pre-sterilized 250 ml Tetra Brik containers by a TBA\9 aseptic filling machine. The packaged soy base was then incubated by immersing the packages in a hot water bath at about 60° C. for about 30 minutes, which was then increased to about 85° C. for about 40 minutes followed immediately by cooling with about 30° C. running water for about 20 minutes.

The resulting aseptic tofu was found to have a very firm texture, a very good taste, good friability, creamy white color and does not lose its shape when cooked.

An independent laboratory (PSB, Singapore) tested the firmness of a 4×4×3.5 (approximately) centimeter sample of the resulting aseptic tofu product. The gel breaking point, which is the force divided by the area of plunger, was found to be about 509.5 g/cm² and about 496.8 g/cm². A gel strength, which is the force applied times the distance the plunger traveled, was found to be about 560 g/cm² and about 585 g/cm² for the two samples.

While the present invention has been described with reference to specific embodiments, this application is intended to cover those various changes and substitutions that may be made by those of ordinary skill in the art without departing from the spirit and scope of the appended claims.

What is claimed is:

1. A method of manufacturing a tofu product from soybeans, the method comprising:
extracting a liquid soy base from the soybeans;
nanofiltering the soy base, thereby concentrating the soy base protein and increasing the total solids content of the soy base;
sterilizing and homogenizing the soy base; and
mixing the soy base with a coagulant in an aseptic mixing process.

2. The method of claim 1, further comprising aseptically packaging the liquid soy product.

3. The method of claim 2, further comprising incubating the aseptically packaged liquid soy base product to form an aseptically packaged tofu product.

4. The method of claim 1, wherein the homogenizing process comprises a first two-stage homogenization process and a second two-stage homogenization process, wherein the first two-stage process is only conducted when soy protein isolate is added to the soy base.

5. The method of claim 4, wherein the second two-stage homogenization process is conducted downstream in an ultra-high temperature sterilization process.

6. The method of claim 1, wherein the coagulant is comprised of transglutaminase, glucono-delta-lactone, MgCl₂, and at least one salt selected from the group consisting of NaCl and a calcium salt.

7. The method of claim 6, wherein the calcium salt is CaCl₂ or CaSO₄.

8. The method of claim 1, wherein the nanofiltering is performed by feeding the soy base through a nanofiltration unit comprising a balance tank, a feed pump, a cooler, a membrane having a pore size of between about 10 nm and about 100 nm, a pressure transmitter and a thermometer.

9. The method of claim 8, wherein the membrane has a pore size of between about 20 nm and about 50 nm.

10. The method of claim 1, wherein the nanofiltering is performed so that the solids content of the soy base after nanofiltration is at least about 16° Brix.

11. The method of claim 1, wherein the sterilizing step comprises of an ultra-high temperature sterilization process.

12. The method of claim 11, wherein the ultra-high temperature sterilization process can be a direct or indirect heating process comprising preheating the soy base to about 75° C. in an indirect tubular heat exchanger, deaerating the soy base to about 70° C., sterilizing the soy base at about 138° C. for about 4 seconds in a tubular heat exchanger, pre-cooling the soy base to about 75° C., conducting a first homogenization process at about 150 bar, conducting a second homogenization process downstream from the ultra-high temperature sterilization process at about 30 bar and cooling the soy base to about 10° C.

13. The method of claim 1, wherein the soy base is provided at a flow rate of about 1,500 liters per hour and combined with about 23.25% by weight transglutaminase, about 76.75% by weight H₂O at a flow rate of about 20 liters per hour, and then combined with about 20% by weight glucono-delta-lactone, about 6.73% by weight MgCl₂, about 6.73% by weight NaCl and about 66.54% by weight water at a flow rate of about 25 liters per hour and mixed with a static in-line mixer.

14. The method of claim 13, wherein at least one of CaCl₂ and CaSO₄ are used instead of or in addition to NaCl.

15. An aseptic tofu product produced by the process of claim 1, the product having a gel breaking point of about 496.8 g/cm² to about 509.5 g/cm² and a gel strength of about 560 g/cm² to about 585 g/cm², when the tofu product tested is in the form of a 4×4×3.5 cm sample.

16. A method of manufacturing a tofu product comprising:
extracting soy base from soybeans;
feeding the soy base through a nanofiltration unit so that after filtration, the soy base has a solids content of at least about 16° Brix;
subjecting the soy base to an ultra-high temperature sterilization process wherein the soy base is heated from about 132° C. for about 15 seconds to about 142° C. for about 2 seconds and homogenizing the soy base; and
mixing the soy base with a coagulant comprising of transglutaminase, glucono-delta-lactone, MgCl₂, and at least one salt selected from the group consisting of NaCl and a calcium salt.

17. The method of claim 16, wherein the calcium salt is CaCl₂ or CaSO₄.

18. A method of manufacturing a tofu product from soybeans, the method comprising:
extracting soy base from the soybeans;
feeding the soy base through a nanofiltration unit so that after filtration the soy base has a solids content of at least about 16° Brix;
subjecting the soy base to an ultra-high temperature sterilization process wherein the soy base is heated to about 132° C. for about 15 seconds to about 142° C. for about 2 seconds; and homogenizing the soy base; and
mixing the soy base with a coagulant comprising providing the soy base at a flow rate of about 1,500 liters per hours and combining the soy base with about 23.25% by weight transglutaminase and about 76.75% by weight water at a flow rate of about 20 liters per hour, and then combining the soy base with about 20% by weight glucono-delta-lactone, about 6.73% by weight MgCl₂, about 6.73% by weight NaCl and about 66.55% by weight water at a flow rate of about 25 liters per hour;

19. An aseptic tofu product produced by the process of claim 16, the product having a gel breaking point of about 496.8 g/cm² to about 509.5 g/cm² and a gel strength of about 560 g/cm² to about 585 g/cm², when the tofu product tested is in the form of a 4×4×3.5 cm sample.
